(19) United States
(12) Patent Application Publication
(10) Pub. No.: US 2026/0249763 A1
(43) Pub. Date: Aug. 27, 2026

(54) AIR CUSHION DEVICE AND SEAT HAVING SUCH AN AIR CUSHION DEVICE AND MASSAGE METHOD FOR APPLYING A PULSATION TO AN AIR CUSHION DEVICE

(71) Applicant: GENTHERM PRÄZISION SE, Treuchtlingen (DE)

(72) Inventors: Erich Dörfler, Treuchtlingen (DE); Jürgen Baumgarti, Treuchtlingen (DE); Helmut Auernhammer, Treuchtlingen (DE)

(21) Appl. No.: 19/148,093

(22) PCT Filed: Jan. 19, 2024
(86) PCT No.: PCT/EP2024/051246

§ 371 Date: Jul. 15, 2025

(30) Foreign Application Priority Data
Feb. 8, 2023 (DE) 10 2023 103 100.7
Feb. 8, 2023 (DE) 20 2023 100 608.6
Jul. 11, 2023 (DE) 10 2023 118 316.8

(51) Int. Cl. B60N 2/90; A61H 9/00; A61H 23/00

(52) U.S. Cl. CPC B60N 2/976; A61H 9/0007; A61H 9/0078; A61H 23/004; A61H 2201/0149; A61H 2201/1238

(57) ABSTRACT

An air cushion device and method for an air cushion device for a seat, that includes at least one air cushion, the at least one air cushion has an air inlet in order to be individually filled with air via an air supply system and a pulsation device, which is fluidically connected to the air cushion, in order to apply a pressure oscillation to the air cushion.

### CROSS REFERENCE TO RELATED APPLICATIONS

This application is a National Stage of PCT/EP2024/051246 filed on Jan. 19, 2024, which claims priority to DE 10 2023 103 100.7 filed on Feb. 8, 2023, DE 20 2023 100 608.6 filed on Feb. 8, 2023, and DE 10 2023 118 316.8 filed on Jul. 11, 2023, all of which are hereby incorporated by reference herein in their entireties for all purposes.

### FIELD

The invention relates to an air cushion device, in particular for a seat, and to a seat having such an air cushion device, and to a massage method for applying a pulsation to an air cushion device.

### BACKGROUND

Electropneumatic massage systems, e.g. for vehicle seats, are known in the prior art. Such a device comprises at least one air cushion, an air supply system, which in particular comprises a pneumatic pump, as well as a valve and a valve control unit to control the inflation and deflation of the air cushion. Such a massage system is known, for example, from DE 100 63 478 A1. Such a massage system can be combined with a lumbar support system.

Furthermore, a pneumatic device for generating and transmitting pressure oscillations to the human body via an air cushion is known from DE 10 2011 079 712 A 1. This is equipped with a pressure generator, a pressure line between the pressure generator and the air cushion and a control unit. U.S. Pat. No. 5,155,685 A describes a seat with a seat shape adjustment device that is controlled depending on an assessment of the occupant's physique. A device for cyclically pressurizing air cushions with air to treat an occupant is known from JP 2005-168 953 A.

With the known systems, the muscles of the seat user are stimulated by stretching, pulling and pressure stimuli in order to increase the well-being of the user and counteract the development of tension during prolonged use of the seat.

### SUMMARY

The object of the invention is to provide an alternative solution for generating a massage. In particular, the device should be suitable for generating an oscillation massage in the sense of andullation therapy.

The object of the invention is solved with regard to the air cushion device by the features of claim 1, solved with regard to the seat by the features of claim 14 and solved with regard to the method by the features of claim 15. Expedient embodiments result from the respective subclaims.

The air cushion device according to the invention for a seat, in particular for a vehicle seat, comprises at least one air cushion, wherein the at least one air cushion has an air inlet in order to be individually filled with air via an air supply system, wherein the air cushion device further comprises a pulsation device which is fluidically connected to the air cushion in order to apply a pressure oscillation to the air cushion. The advantage of the air cushion device according to the invention is that the air cushion(s) can be filled once with a desired filling volume, and the pressure oscillation can then be generated exclusively via the pulsation device. A further advantage is that with the use of a separate pulsation device both the frequency and amplitude of the pressure oscillation can be set over a larger adjustment range.

Conveniently, the air cushion device comprises multiple air cushions arranged as an air cushion arrangement.

In particular, the pulsation device is arranged parallel to an air supply system, which in particular comprises one or multiple supply lines and one or multiple shut-off valve(s).

Conveniently, the at least one air cushion comprises a further air inlet, wherein the pulsation device is fluidically connected to the further air inlet. The further air inlet can be located next to the air inlet or on another side of the air cushion. Conveniently, a line is arranged between the further air inlet of the air cushion and the pulsation device. This embodiment allows a flexible arrangement of the air cushion device in the installation space of a seat.

The further air inlet can also assume the function of an air outlet, which is fluidically connected to an air release device, which in particular comprises an outlet valve. The or respectively each air cushion can also have a separate air outlet which is connected to an air release device.

In one embodiment, the pulsation device comprises a pneumatic element comprising an air chamber with a variable volume. Furthermore, the pulsation device comprises a drive element and/or actuating element for changing the volume in the air chamber, also known as the interior volume, wherein the air chamber is fluidically connected to the air cushion. In one embodiment, the air chamber can comprise a membrane which is moved by the drive element and/or actuating element. The air chamber can be arranged in a line. In one embodiment, the air chamber can be formed by a cushion, which is further designed as a pneumatic cushion.

An air chamber is conveniently connected to exactly one air cushion. Alternatively, a group of two or more air cushions can be connected to an air chamber.

In one embodiment, exactly one actuating element is assigned to an air chamber. An actuating element can be a plunger, for example, which limits an air chamber from one side.

In one embodiment, the air cushion device comprises a pulsation module, which comprises one or more pulsation devices.

Conveniently, the drive element is one of a magnetic oscillating drive, a mechanical crank drive or an electroactive polymer.

In one embodiment, the pulsation device generates a low-frequency vibration. Such a low-frequency vibration is in particular in the range from 0.5 Hz to 1000 Hz, in particular between 3 Hz and 100 Hz, in particular below 70 Hz.

Conveniently, the air supply system comprises a pump. Alternatively, the air supply system can also comprise a connection to a central compressed air supply.

The air supply system conveniently comprises a valve control unit and a valve for each air cushion, wherein the valve control unit controls the valve(s). The valves can be arranged in one or multiple valve units. The function of a valve control unit can also be performed by a central control unit in the vehicle. This allows the air volume of individual air cushions to be controlled individually. In particular, the air cushions can be pneumatically separated from the air supply to operate the pulsation device. The present air cushion device can thus also be designed as a lumbar support device or respectively for an individual contour adjustment of the seat.

In one embodiment, a vibration device is arranged in through-flow geometry with the air supply system or in a supply line between the valves or, respectively, valve units of the air supply system and air cushions or connected to the supply line between valves or, respectively, valve units and air cushions via a T-piece. A vibration device is known, for example, from DE 10 2019 113 629 A1. In this embodiment, it is possible to apply two different oscillations to the air cushions simultaneously or with a time offset. For this purpose, it is convenient to connect the vibration device to the air inlet and the pulsation device to the further air inlet of the air cushion. Alternatively, the vibration device can also be designed as a vibrator that is non-fluidically connected to the air cushion. The vibration device and pulsation device are arranged separately from each other and can be controlled separately.

In one embodiment, the pulsation device is connected to a group of air cushions. The group of air cushions can be connected to the air supply via the same or different valve control units. Here, the oscillation can be applied to multiple or all air cushions in phase or with a phase offset.

In an embodiment, a pulsation device can be provided for each air cushion.

In one embodiment, the actuating element is configured for out-of-phase actuation of multiple pneumatic elements.

In one embodiment, the actuating element comprises a pivot arm which can be pivoted through an angle about an axis, wherein respectively at least one pneumatic element is arranged on opposite sides of the pivot arm; or wherein the actuating element is arranged so as to be movable linearly along an actuating path, wherein respectively at least one pneumatic element is arranged on opposite sides of the actuating element.

In one embodiment, the pulsation device comprises a cylinder, in the interior of which pneumatic elements with an interior volume connected to the line in a pressure-balanced manner are arranged concentrically, wherein the actuating element comprises a roller arranged eccentrically to the cylinder within the cylinder, wherein the pneumatic elements and the actuating element are arranged in such a way that an eccentric movement of the roller about the longitudinal axis of the cylinder can change the interior volume of the pneumatic elements for applying a pulsation to the air cushion.

In one embodiment, the air cushion device, in particular formed with a drive element for the actuating element, is configured with the pulsation device, in particular the actuating element, to effect a pulsation with a frequency of 1 Hz to 1000 Hz or 3 Hz to 100 Hz or 60 Hz to 80 Hz or between 5 and 20 Hz, in particular between 5 and 15 Hz, particularly preferably between 7 and 12 Hz.

Alternatively or additionally, the air cushion device is formed to implement a massage function and/or an entertainment function and/or a line assist function and/or a lane change warning function.

The seat according to the invention, in particular the vehicle seat, comprises an air cushion device according to the invention.

Conveniently, the air cushion device is integrated into a backrest and/or a seat surface of the seat.

In one embodiment, the air cushions are arranged in at least one, in particular at least two, in particular at least four rows.

The massage method according to the invention for an air cushion device, in particular an air cushion device in a seat, wherein the air cushion device comprises a number N, with N>1, of air cushions Lᵢ, wherein 1≤i≤N, comprises:
Step 1 Filling an air cushion Lᵢ to a first threshold value S1ᵢ for the air cushion Lᵢ,
Step 2 Applying a pulsation Paᵢ to the air cushion Lᵢ,
   wherein the first threshold value S1ᵢ is selected for at least one of the N air cushions Lᵢ such that the air cushion is at least partially filled with air.

The air cushion device can be designed in particular as described above.

The threshold value S1ᵢ can be different for each of the air cushions Lᵢ or selected to be the same for multiple or all air cushions Lᵢ.

Here, i and N respectively are a natural number. The massage method can be performed selectively for one, multiple or all air cushions Lᵢ. A pulsation Paᵢ has an amplitude Aaᵢ and a frequency faᵢ. The amplitude Aaᵢ is selected such that a change in the filling volume and/or filling pressure of the respective air cushion between an empty state and an air cushion filled at the first threshold value S1ᵢ for the air cushion Lᵢ is considerably greater than the amplitude Aaᵢ. In particular, a pressure in the air cushion at the threshold value S1ᵢ is considerably greater than a pressure difference that represents the amplitude Aaᵢ. In the context of the present invention, considerably larger is to be understood as at least twice as large, in particular three times or four times or five times as large. The amplitude Aaᵢ and the frequency faᵢ can be different for each of the air cushions Lᵢ or selected to be the same for multiple or all air cushions Lᵢ. The amplitude Aaᵢ can vary depending on time.

Steps 1 and 2 can be carried out simultaneously, partially overlapping or one after the other.

In one embodiment, the first threshold value S1ᵢ is a first filling pressure P1ᵢ or a first filling volume V1ᵢ in the air cushion Lᵢ.

In a further embodiment, step 2 is performed after ending step 1. This means that the filling of the air cushion is ended, in particular by pneumatically disconnecting the air cushion from an air supply system, which is conveniently provided for filling the air cushion, or by interrupting an air supply by an air supply system.

In one embodiment, the method further comprises:
Step 3 Emptying an air cushion Lᵢ to a second threshold value S2ᵢ for the air cushion Lᵢ, wherein step 3 is carried out after step 1 or after steps 1 and 2.

Emptying up to a second threshold value S2ᵢ for the air cushion Lᵢ can be a complete or almost complete emptying of the air cushion Lᵢ or a partial emptying of the air cushion Lᵢ.

The threshold value S2ᵢ can be different for each of the air cushions Lᵢ or selected to be the same for multiple or all air cushions Lᵢ.

In one embodiment, the method further comprises:
Cyclically carrying out steps 1 and 3 so that a standard massage oscillation Pbᵢ is applied to the air cushion Lᵢ, so that the standard massage oscillation Pbᵢ and the pulsation Paᵢ are applied to the air cushion Lᵢ simultaneously or intermittently.

A standard massage oscillation Pbᵢ has an amplitude Abᵢ and a frequency fbᵢ. For such a standard massage oscillation, in particular each of the air cushions can be filled via a valve and emptied via the same or a further valve. The amplitude Abᵢ is larger than the amplitude Aaᵢ, in particular at least twice as large, and the frequency fbᵢ is smaller than the frequency faᵢ, in particular at least half as small. In one embodiment, steps 1, 2 and 3 are carried out one after the other, so that after step 1 has been completed, step 2 is carried out first and step 3 is carried out after step 2 has been completed. Alternatively, step 3 can also be carried out with a time offset and partially overlapping with step 2. The amplitude Abᵢ and the frequency fbᵢ can be different for each of the air cushions Lᵢ or selected to be the same for multiple or all air cushions Lᵢ.

In a further embodiment, step 1 and step 3 are performed alternately, while step 2 is performed non-intermittently over multiple or all cycles of the standard massage oscillation.

In a preferred embodiment of the method, a first pressure maintaining interval is provided after step 1 and before step 3. A pressure maintaining interval should be understood to mean that the air cushion is neither actively filled nor emptied. A pressure fluctuation due to pulsation is possible.

In a further preferred embodiment of the method, a second pressure maintaining interval is provided after step 3 and before step 1.

In one embodiment, the pulsation Paᵢ has a frequency faᵢ of 1 Hz to 1000 Hz or 3 Hz to 100 Hz or 60 Hz to 80 Hz or between 5 Hz and 20 Hz, in particular between 5 Hz and 15 Hz or between 4 Hz and 12 Hz or between 7 Hz and 12 Hz.

In a further embodiment, the pulsation Paᵢ takes place with a pressure difference, i.e. amplitude, of 5-100 hPa, in particular 10-50 hPa, and/or the pulsation Paᵢ takes place with a volume difference, i.e. amplitude, of 5-15 ml, in particular 6 to 12 ml, in particular 7 to 10 ml, and/or the pulsation Paᵢ takes place with a volume difference of at most 50% of the maximum filling volume, in particular at most 30% of the maximum filling volume, in particular 5% to 15% of the maximum filling volume.

In a further embodiment, the second threshold value and the first threshold value are pressure threshold values, wherein a difference between the first threshold value and the second threshold value is 500 hPa, in particular 50 hPa-300 hPa, in particular 100 hPa-200 hPa, or
wherein the second threshold value and the first threshold value are volume threshold values, wherein a difference between the first threshold value and the second threshold value is 0-150 ml, in particular 20-100 ml, in particular 30-70 ml, or
wherein the second threshold value and the first threshold value are volume threshold values, wherein a difference between the first threshold value and the second threshold value is 100%-40% of the maximum filling volume, in particular 60%-90% of the maximum filling volume.

In one embodiment, an air supply system comprises a pump for filling the air cushion Lᵢ, which runs exclusively while step 1 is being performed. This means that the pump is switched on at the start of step 1 and switched off upon completion of step 1.

Conveniently, the pulsation is generated by a pulsation module which can be connected or is connected to each air cushion Lᵢ or to a first group of air cushions and generates a pulsation continuously or at a predetermined time interval. In particular, this means that a pulsation module is separate from the air supply and pulsation conveniently can take place without supplying or removing air from the air cushion device.

In one embodiment, the steps step 1, step 2 and optionally step 3 for the N air cushions take place in a predetermined sequence, so that step 1 for the air cushion Lᵢ begins at the time t1ᵢ and step 2 for the air cushion Lᵢ begins at the time t2ᵢ and optionally step 3 for the air cushion Lᵢ begins at the time t3ᵢ.

In a further embodiment, at least one group of the air cushions is arranged such that the air cushions Lᵢ₋₁ and Lᵢ₊₁ are arranged on opposite sides of the air cushion Lᵢ, wherein each step starts at a time t−Δt for the air cushion Lᵢ₋₁ and at a time t+Δt for the air cushion Lᵢ₊₁. With a group of air cushions arranged in a vertical row, for example, the lowest air cushion can be filled and subjected to a pulsation first, then the one above it and finally the uppermost one. Optionally, after the uppermost air cushion, the next one below can be filled or subjected to pulsation so that the pulsation moves up and down in waves or, alternatively, the same air cushion of the group can always be started with and the pulsation only moves in one direction through the air cushions. This means that with a row of 4 air cushions L₁ to L₄, for example, the control would take place cyclically in a wavelike manner in the following sequence:

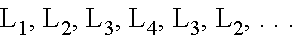

If the control is always in the same sequence, it would be:

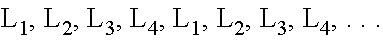

The N air cushions can be divided into at least two groups, which are arranged in particular in a respective row or a cluster, wherein the air cushions of a group are respectively controlled in parallel or wherein respectively one air cushion in a group is controlled in parallel with a corresponding air cushion of the other group(s). For example, the air cushions can be arranged in 2, 3 or 4 vertical rows of a seat, or the air cushions can be arranged in multiple horizontal rows in the backrest of a seat. In such an arrangement, for example, one air cushion each from a vertical row, which are at the same height, can be filled in parallel and simultaneously be subjected to a pulsation which is, for example, in-phase or antiphase. A targeted sequence of controlling the cushions with the pulsation and optionally the standard massage oscillation can be used to in particular stimulate or prevent a movement of the user.

A further alternative is, for example, a first group in the region of the seat surface or, respectively, seat cushion, a group in the region of the lower back and a group in the region of the shoulders. Combinations of the above are possible.

The invention is also explained in more detail below with regard to further features and advantages by means of the description of embodiment examples and with reference to the accompanying drawings. The drawings respectively show the following in a schematic principle diagram:

### BRIEF DESCRIPTION OF THE FIGURES

FIG. 1 is a schematic diagram of an air cushion device.

FIG. 2A-2C illustrate an air cushion device.

FIG. 3 illustrates a pulsation device.

FIG. 4 illustrates a seat.

FIG. 5 is a further schematic diagram of an air cushion device.

FIG. 6A-6C illustrate embodiments of a pulsation device.

FIG. 7 illustrates a further embodiment of a pulsation device.

FIG. 8 illustrates a pulsation device with a pivot arm.

FIG. 9 illustrates a further embodiment of a pulsation device.

FIG. 10 illustrates an implementation of the gearbox between the drive motor and the pulsation element.

FIG. 11 is a schematic representation of an air cushion device in a backrest with 8 air cushions,

FIG. 12 is a schematic representation of an air cushion device in a backrest with 12 air cushions.

FIG. 13 is a schematic representation of a further air cushion device in a backrest with 8 air cushions.

FIG. 14 is a schematic representation of a further air cushion device in a backrest and a seat surface.

FIG. 15 is a schematic representation of the massage in an air cushion according to an embodiment.

FIG. 16 is a schematic representation of the massage in an air cushion according to an embodiment.

FIG. 17 is a schematic representation of the massage in an air cushion according to an embodiment.

FIG. 18 is a schematic representation of the massage in an air cushion according to an embodiment.

FIG. 19 is a schematic representation of the massage in an air cushion according to an embodiment.

FIG. 20 is a schematic representation of the massage in two air cushions according to an embodiment.

FIG. 21 is a schematic representation of the massage in two air cushions according to an embodiment.

FIG. 22 is a schematic representation of the massage in four air cushions according to an embodiment.

FIG. 23 illustrates a further air cushion device.

### DETAILED DESCRIPTION

FIG. 1 shows a schematic circuit diagram of a first air cushion device 2. In the embodiment shown, the air cushion device 2 comprises three air cushions 6, each of which has an air inlet 8 and a further air inlet 9. The air cushions 6 are connected to a common air supply system 10, which in particular comprises a pump 11. A valve 14, in particular a controllable valve, is arranged in each supply line 16 between the air supply system 10 and the air cushion 6. A pulsation device 20 is arranged parallel to the air supply device 10, which pulsation device is connected to the air cushion 6 via a line 17 respectively at the connection 9. A further valve 26 can be arranged in each of the lines 17 to direct the oscillation to the individual air cushions in a targeted manner or, respectively, to protect the pulsation device from excessive air flow when filling or emptying the air cushions 6. Furthermore, the valve(s) 26 can also assume the function of an air release device and be designed for this purpose.

As shown, the air cushions 6 can consist of two interconnected chambers. A deviating embodiment of the air cushion is possible, e.g. with only one or with more than two chambers.

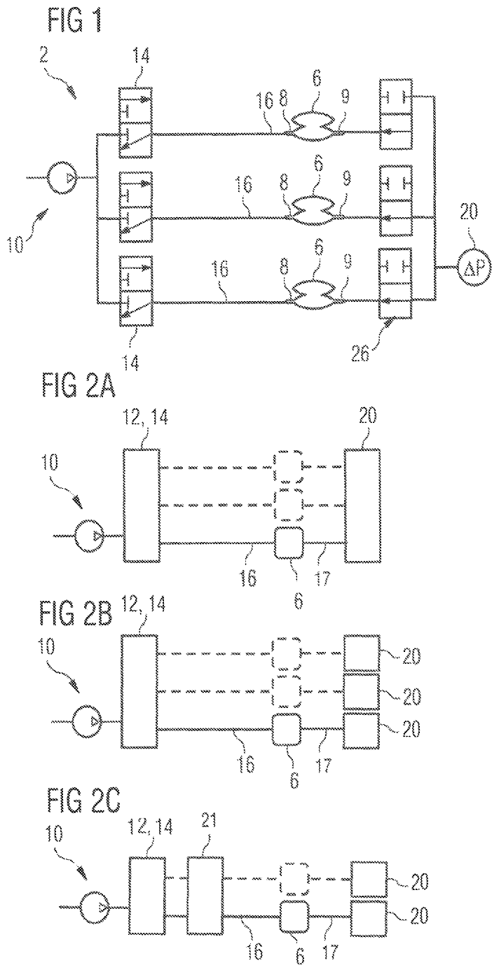

FIGS. 2A-2C show three embodiments of the air cushion device 2. In FIG. 2A, three air cushions 6 are again connected to an air supply system 10. A valve control unit 12 with three valves 14 is incorporated on the side of the air supply system 10. A pulsation device 20 is connected to the air cushions 6 via the lines 17. The individual lines 17 are pneumatically separated from the respective other lines.

FIG. 2B shows an alternative embodiment. Each air cushion 6 is provided with its own pulsation device 20.

FIG. 2C shows a further embodiment of the air cushion device 2. The air cushion device 2 is provided with a pulsation device 20 and a vibration device 21, which, as an example here, is arranged in the supply line 16 pneumatically from the air supply device 10. An alternative arrangement of the vibration device 21 in the air supply device 10 or the provision of individual vibration devices in each supply line 16 is equally possible as a combination of a vibration device 21 with the embodiment of FIG. 2A.

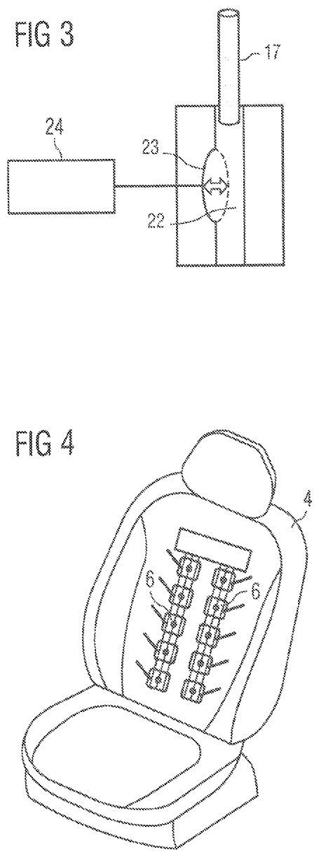

FIG. 3 shows an embodiment of a pulsation device 20, which can be arranged on a line 17. The pulsation device 20 comprises an air chamber 22, which can be enlarged or reduced in volume using a drive element 24. For this purpose, as shown here, a limit of the air chamber 22 can be formed by a membrane 23, for example.

FIG. 4 shows an embodiment of a seat 4, in particular a vehicle seat. The seat 4 comprises air cushions 6, which are arranged in two rows in the backrest of the seat. The air cushions 6 are part of an air cushion device 2 according to the invention. The pulsation device 20 can conveniently apply an oscillation to each of the two rows of air cushions 6 independently of the other row. Alternatively, an oscillation can be applied to each of the air cushions 6 independently via multiple pulsation devices or a pulsation device and a vibration device.

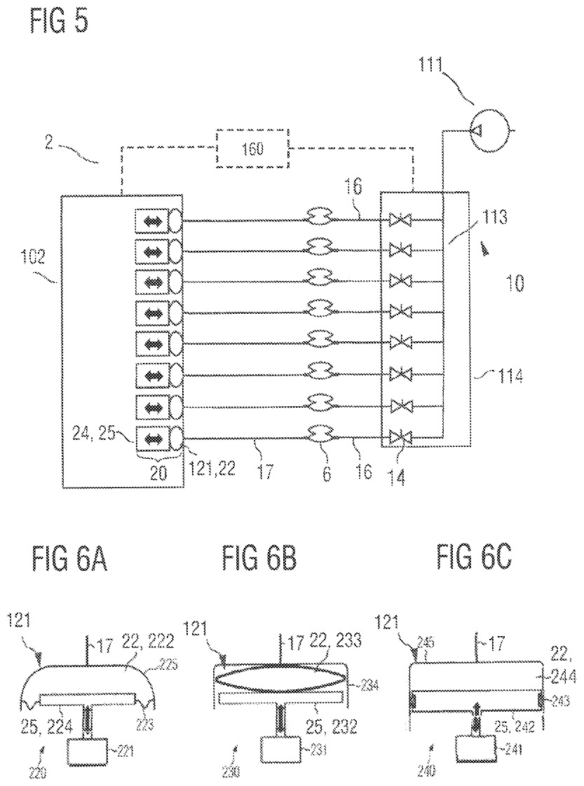

FIG. 5 shows a further schematic diagram of an air cushion device 2. The air cushion device 2 comprises a plurality of air cushions 6, which are connected to an air supply system 10 via supply lines 16. The air supply system 10 comprises a common pressure supply 111, which is connected to the individual supply lines 16 via a valve unit 114 with a plurality of valves 14. In this embodiment, a valve 14 is assigned to each air cushion 6. In principle, it is also possible, for example, to assign a valve 14 to air cushions 6 in pairs so that respectively two air cushions 6 are filled at the same time. When a target pressure is reached in the respective air cushion 6, the respective valve 14 can be closed so that the air cushion 6 is pneumatically separated from the air supply 10. The valves can be controlled, for example, via the control unit 160, such as the on-board computer of a vehicle.

In one embodiment, the control unit 160 can control a separate valve control unit or comprise such a unit. In the embodiment shown, the control unit 160 also controls the pulsation module 102, as described further below.

In this way, a wide variety of functions can be implemented in a targeted manner. For example, the massage function mentioned above can be implemented by applying air to the individual air cushions at different frequencies or in opposite directions or alternately. Certain entertainment functions, such as support for acoustic effects like music or films, can also be achieved in this way by applying air to individual or multiple air cushions. Alternatively or additionally, it can also be provided that assistance systems of a vehicle are implemented by applying air to the air cushions or releasing the air. For example, a line assist function and/or a lane change warning function can be implemented with the air cushion arrangement. For example, when changing lanes from the right to the left lane, air can be applied to a row of air cushions mounted on the left side of the seat in the direction of travel to warn the driver that a lane change is imminent. The air cushions mounted on the right in the direction of travel can then remain empty, i.e. without air being applied to them.

In principle, air cushions arranged laterally in the seat (e.g. laterally in the region of the backrest and/or the seat surface and/or in the bolsters of the seat surface and/or the bolsters of the backrest) could be equipped with a corresponding pulsation device or a corresponding pulsation module. Air cushions arranged in the bolsters can also be used to adapt the contour of the seat to the body shape of the occupant by applying more or less air, according to the body shape of the occupant, to the air cushions arranged in the bolsters in order to provide the occupant with lateral support regardless of their stature. The air cushions of these bolsters can then not only enable adaptation to the body shape, but also implement additional functions such as massage, lane change warning function and entertainment functions, including pulsation.

The air cushion arrangement can also be used to implement other functions that can utilize the support provided by such a pressure effect on the body in order to provide the operator with certain information. The invention is thus not limited in this respect, although the use in vehicles as part of a vehicle seat and in particular the use as part of an air cushion device in the vehicle seat is preferred.

The above additional functions can be effected not only by applying and releasing the air from the air cushions. Alternatively or additionally, the provided pulsation according to the invention can also be used for this.

The air cushion device 2 further comprises a pulsation module 102 which has a plurality of pulsation devices 20. In the present case, the number of pulsation devices 20 is identical to the number of air cushions 6. In the case shown, each pulsation device 20 is connected to the air cushion 6 via the respective line 17 without a valve. However, an additional valve 26 can optionally be arranged in the lines 17.

Each pulsation device 20 comprises an actuating element 25 and an air chamber 22. In one embodiment, the air chamber 22 can be designed as a cushion. The air chamber 22 has a variable volume, so that when there is an increase in the volume of the air chamber 22, the pressure in the air chamber 22, in the line 17, in the air cushion 6 and in the supply lines 16 up to the valve 14 (when the valve 14 is closed) is decreased, and when there is a decrease in the volume of the air chamber 22, the pressure in the air chamber 22, in the line 17, in the air cushion 6 and in the supply lines 16 up to the valve 14 (when the valve 14 is closed) is increased. An increase in the volume of the air chamber 22 or a decrease in the volume of the air chamber 22 is achieved via the actuating element 25.

FIGS. 6A to C show various embodiments of pulsation devices 20, which are referred to here as pulsation device 220, pulsation device 230 and pulsation device 240. In the embodiment of the pulsation device 220 shown in FIG. 6A, it is provided that the pneumatic element is partially formed by the actuating element 224. The actuating element is configured here as a plunger, for example, which can be moved by the drive 221 (such as an electric motor, in particular a servomotor) in the direction of the arrow shown. The movement of the actuating element 224 takes place within an interior volume 222 of the air chamber 22, which volume is partially limited by a limit surface (also called working space) 225 of the pneumatic element 121. Furthermore, the interior volume 222 of the pneumatic element thus formed is limited by a (preferably) flexible membrane 223. This creates an interior volume 222 that is sealed off towards the outside and is connected to the line 17 in a pressure-equalized manner as shown in FIG. 5.

If the actuating element 224 is now moved by the drive 221, the interior volume 222 changes (for example periodically). The resulting change in the pressure of the air within the interior volume 222 is then transmitted via the line 17 to the air cushion 6 not shown in FIG. 6A, which can effect a pulsation in the air cushion 6. According to this embodiment, but also according to all other described embodiments, frequencies between 1 Hz and 1,000 Hz can be preferred here. For a massage function or similar functions of a vehicle seat, oscillations between 3 Hz and 100 Hz, in particular between 60 Hz and 80 Hz and particularly preferably at around 70 Hz or between 5 and 20 Hz, in particular between 5 and 15 Hz, particularly preferably between 7 and 12 Hz, have proven to be particularly pleasant for a person, so that even long-term use of a corresponding function is not unpleasant for people.

In FIG. 6B, a further embodiment of a pulsation device 230 is shown, which differs essentially from FIG. 6A in that the pneumatic element is formed entirely by an air cushion, hereinafter referred to as pneumatic cushion 233, which has an interior volume and a flexible outer shape which can be changed by the actuating element 232, for example by squeezing or, respectively, compressing the pneumatic element 121 configured as a pneumatic cushion 233.

In order to prevent the pneumatic cushion from deflecting against the mechanical movements of the actuating element 232, it may be provided that the pneumatic cushion 233 is arranged in a frame 234 or, respectively, in a holder and, if necessary, is also mechanically connected thereto (for example by bonding), so that preferably a guided movement of the actuating element 232 and the pneumatic cushion 233 can be effected, which only takes place within the frame 234, so that the change in the interior volume of the pneumatic cushion 233 effected by the actuating element 232 can be completely converted into pressure information or, respectively, pulsation that can be transmitted through the line 17. This embodiment offers the advantage that only the pneumatic cushion acts as a pneumatic element and the actuating element is completely independent thereof, in particular is not provided as forming part of the interior volume.

While the flexible membrane 223 in FIG. 6A thus ensured reliable sealing of the interior volume 222 even during movement of the actuating element, the movement of the actuating element now no longer needs to be additionally sealed against the environment.

FIG. 6C shows a further embodiment of a pulsation device 240. In the embodiment shown here, compared to FIG. 6A, a sealing arrangement 243 is provided instead of the flexible membrane 223, which sealing arrangement together with the actuating element 242 and the housing 245 encloses an interior volume 244. Here too, the interior volume 244 can then be changed by the movement of the actuating element 242 by means of the drive 241 to supply the corresponding pulsation to a downstream air cushion via the line 17.

This embodiment offers the advantage that the interior volume 244 of the pneumatic element is practically completely limited by mechanically non-compressible elements (the actuating element 242 and the housing 245). The sealing element or, respectively, the sealing arrangement 243 can be made of a comparatively hard rubber, for example. This means that the available volume is not exposed to “wear and tear” over long periods of operation, as would be the case for the air cushion and the flexible membrane 223. These can be subject to material fatigue, which can make them more difficult or more susceptible to failure when used to effect the pulsation over long operating periods or, respectively, service lives.

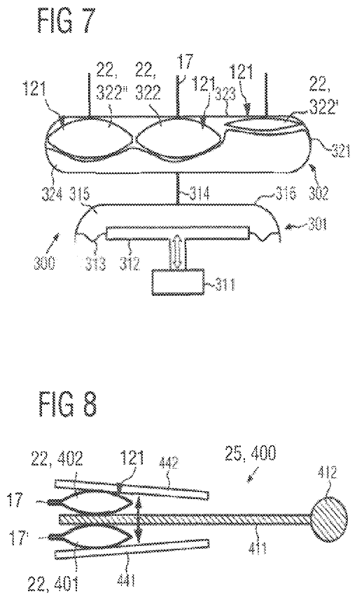

FIG. 7 shows an embodiment with a multi-stage design in which the movement of the actuating element (i.e. the mechanical actuation) is decoupled from the pneumatic elements. For this purpose, it is provided that one or multiple pneumatic elements 121 (for example in the form of pneumatic cushions 322) are arranged in a spatial region which is limited on the one hand by a housing or other suitable limit 323 and on the other hand by a flexible membrane 321. For their part, as in the previous embodiments, the air cushions are each preferably connected to exactly one air cushion 6 of the air cushion arrangement by the line 17.

The region formed on the opposite side of the flexible membrane 321 is connected to a further air volume 301 via a line 314. This air volume, which is formed in the region between the flexible membrane 321, the line 314 and the region 315, is preferably constant and fluidically separated from the pneumatic cushions and the air cushions. As in FIG. 6A, the region 315 is limited on the one hand by the actuating element 312 and the actuator 311 assigned to it, as well as by a flexible membrane 313 and a housing 316.

If the actuating element 312 is now actuated, this causes the pressure within the regions 315 and 324 as well as the line 314 to change, since the available volume changes. This acts via the flexible membrane on the pneumatic cushions 322, which deform accordingly and transmit a pulsation (during pulsed movement of the actuating element) to the air cushions connected to them via line 17. This embodiment can be used particularly advantageously to use a single actuating element to actuate multiple pneumatic elements. As shown here, the pneumatic cushions 322 and 322″ are filled with air, i.e. pressure has been applied to the corresponding line 17. The pneumatic cushion 322′ is shown flattened, in particular empty of air, as no compressed air has been introduced in the assigned supply line. This ensures that even when the actuating element is actuated, no undesired pulsation is effected in the air cushion assigned to the pneumatic cushion 322′ at the other end of the associated supply line. Despite a single actuating element for a group of pneumatic elements, this ensures that only the air cushions or air cushion arrangement to which air has been applied are subjected to a pulsation.

In an alternative embodiment, according to FIG. 6B, it may also be provided that multiple pneumatic cushions are arranged in the housing 234. A “pressureless” pneumatic cushion, such as the pneumatic cushion 322′, will then not transmit any pressure information to the associated air cushion of the air cushion arrangement, even by mechanical stroke of the actuating element. To further ensure this, it can be provided that in such a case the movement of the actuating element is adjusted with regard to its amplitude in such a way that the actuating element does not touch a pressureless pneumatic cushion, so that even a proportion of “residual air” remaining in the pneumatic element does not effect any undesirable pulsation in the associated air cushion.

FIG. 8 shows a further embodiment of an actuating element 400, wherein the actuating element in this embodiment is configured as a pivot arm 411 pivotable about an axis 412. In the embodiment shown here, two pneumatic cushions 401 and 402 are provided, wherein the first pneumatic cushion 401 is arranged on one side of the pivot arm and the second pneumatic cushion 402 is arranged on the opposite side of the pivot arm. Furthermore, counter-pressure elements 441 and 442 are provided in such a way that the pneumatic cushions are respectively arranged between the pivot arm 411 and the counter-pressure element assigned thereto, which effects a stabilization of the position of the pneumatic cushions. This ensures that the mechanical information transmitted to the pneumatic cushion is converted as completely as possible into pressure information, which can be transported as pulsation through the respective lines 17, 17′.

In the embodiment shown here, it is now provided that the actuating element in the form of the pivot arm 411 is pivoted about the axis 412 in the double-arrow direction shown. In this way, one pneumatic cushion 401 is alternately unloaded and the other pneumatic cushion 402 is loaded or, respectively, vice versa, which effects an out-of-phase loading of the pneumatic cushions 401 and 402, so that also the pulsation runs exactly out of phase through the lines 17, 17′. This is particularly advantageous to avoid resonances in the air cushion arrangement, which can have an unpleasant effect on people.

While in the embodiment shown here only one pneumatic cushion is arranged on each side of the pivot arm 411, multiple pneumatic cushions can also be arranged (in a direction perpendicular to the image plane of FIG. 8) so that, for example, different groups of pneumatic cushions can be operated out of phase. Here, too, it can be provided that pressureless pneumatic cushions are either not touched by the pivot arm 411 or at least do not transmit any pressure information to the air cushions of the air cushion arrangement associated with them, so that it is also possible to switch off (release the air) separate air cushions without causing a pulsation in them.

Moreover, there is no need for any pivoting. In some embodiments, instead of the pivot arm, it can also be provided that the actuating element can be moved linearly, in which case pneumatic elements can be arranged on opposite sides of the actuating element (for example also using corresponding counter-pressure elements 441 and 442) in such a way that the movement of the actuating element, analogous to the above embodiment of FIG. 8 above, effects alternating loading of one pneumatic element and unloading of the other pneumatic element to cause a pulsation in the air cushion or, respectively, in the air cushions assigned to the pneumatic elements during (periodic or repeated) movement of the actuating element.

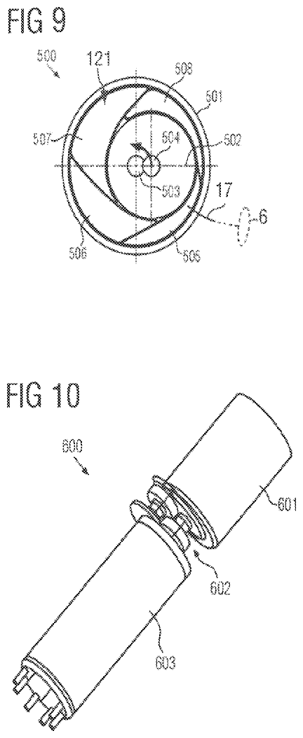

FIG. 9 shows a further embodiment of the invention, wherein in this embodiment the pulsation device 500 is designed as a cylinder, which is shown here only in a cross-sectional view, wherein the image plane of FIG. 9 runs perpendicular to the longitudinal axis of the cylinder.

In the embodiment shown here, a row of pneumatic cushions 505 to 508 is arranged on the inner wall of an outer limit cylinder 501. This can be implemented, for example, by bonding the pneumatic cushions or other mechanical fastening, such as screwing or clamping, as long as it is ensured that the pneumatic cushions are sealed airtight. Each of the pneumatic cushions (shown in the example of the pneumatic cushion 505) is connected to an air cushion 6 of the air cushion arrangement via a corresponding line 17 leading out of the outer limit cylinder 501.

Preferably, the pneumatic cushions 505 to 508 have the same shape and/or the same volume. Furthermore, an actuating element 502 is arranged in the outer limit cylinder 501, which in this embodiment is realized as a roller arranged eccentrically to the longitudinal axis of the outer limiting cylinder 501, which extends at least along a part of the total length (perpendicular to the image plane) of the outer limit cylinder 501.

It can be provided that the roller either has a cylindrical shape or exhibits (slight) deviations from the cylindrical shape. In particular, deviations can be provided on the base surface and the top surface of the roller (corresponding to the base surfaces and top surfaces of the outer limit cylinder 501, which effect the roller to be beveled towards the base surface or, respectively, the cover surface, for example. It may be provided, for example, that starting from the center point of the roller, the radius of the roller is decreased in the direction of the base surface or, respectively, the cover surface. This can preferably take the shape of a curve (such as a parabolic section) in order to avoid edges and thus undesirable loads on the pneumatic cushions.

In the embodiment shown here, the roller rotates with its central axis 504 about the central axis 503 of the outer limit cylinder during operation of the actuating element. Due to the eccentric arrangement of the roller 504, this results in the pneumatic cushions 505 to 508 being deformed to varying degrees when the roller 502 rotates about the axis 503, as can already be seen in FIG. 9. The pneumatic cushion 505 is highly deformed here, so its volume is significantly smaller than that of the pneumatic cushion 507. This again generates pressure information in the pneumatic cushions, which can be transmitted as pulsation (with repeated and/or periodic rotation of the roller) via the line 17 to the air cushions 6 of the air cushion arrangement.

While in the embodiment shown here the roller is arranged within the region in which the pneumatic cushions are arranged, it can also be provided that the pneumatic cushions are surrounded by an actuating element in the cylinder 501, which actuating element is configured as a hollow roller, in which case the pneumatic cushions are firmly connected to a physically configured axis 503 of the limit cylinder 501, for example, in order to fix their position. The roller then rotates eccentrically about the outside of the pneumatic cushions, thus effecting the desired deformation to generate the pulsation. While in the embodiment shown in FIG. 9 the roller comes into direct contact with the pneumatic cushions, it may also be provided that spacers, for example in the form of rubber elements or generally elastic elements, are arranged on the surface of the pneumatic cushions, which surface faces the roller 502, with which spacers the roller 502 interacts during its rotation to transfer a mechanical movement of the roller into a deformation of the pneumatic cushions. This reduces wear on the surface of the pneumatic cushions.

Additionally or alternatively, it may be provided that a lubricant, such as a lubricating grease, is applied to the contact surface of the pneumatic cushions with the roller and/or that the pneumatic elements (in particular pneumatic cushions) are equipped with a TPU film on their contact surface so that friction with the cylinder is reduced. Both embodiments allow a reduction in the physical load on the pneumatic elements so that their longevity can be advantageously increased.

Furthermore, it may be provided that a seam of the pneumatic cushions is arranged in such a way that the physical load acting on the seam is as low as possible. Such a seam is provided to close the pneumatic cushion. The seam can be bonded, for example, by heating and partially melting the material of which the pneumatic cushion is made. If the seam were to run perpendicular to the image plane shown in FIG. 9, i.e. parallel to the axis 503 of the limit cylinder 501, this would mean that the pneumatic cushion is simultaneously loaded over its entire length along the seam by the longitudinal movement of the roller. In order to avoid this, it can be provided that the seam, starting from the upper end or, respectively, the upper corner surface of the outer limit cylinder 501 in the direction of the lower limit surface of the outer limit cylinder, also extends at least partially in the circumferential direction, so that it forms an angle with the axis of the outer limit cylinder 501. This ensures that when the roller 502 is rotated, the entire seam of the pneumatic cushion is not loaded at the same time, but rather different regions of the seam are loaded at different rotational positions of the roller, which effects a distribution of the forces acting on the pneumatic cushion and thus achieves an improvement in the expected service life of the pneumatic cushion.

In order to enable this embodiment to be installed in as little space as possible, for example in a backrest of a vehicle seat, it can be provided that the expansion of the air cushion, the roller and the outer limit cylinder in a direction perpendicular to the image plane is as small as possible, preferably not greater than 2 cm or not greater than 3 cm. In order to nevertheless ensure a sufficient volume for effecting a pulsation, it can be provided that the inner diameter of the outer limit cylinder is at least 5 cm, preferably at least 7 cm, but preferably no more than 10 cm. The roller and the pneumatic cushions can then be dimensioned according to the requirements, wherein the volume of the pneumatic cushions or pneumatic elements in general also depends on the number of pneumatic elements provided.

An electric motor, in particular a servomotor, can generally be used as a drive for the actuating elements (not only in FIG. 9 or FIG. 6). However, since the frequency at which the pulsation is to be generated in the air cushions of the air cushion arrangement can deviate in part from the usual rotational frequencies for servomotors, it can be provided that a connection of the drive and the actuating element is mediated via a gearbox which implements a specific transmission ratio.

Such an arrangement is shown schematically in FIG. 10. The drive motor is shown here as drive motor 601 and can be configured as an electric motor or servomotor, for example. Between this drive motor 601 and the pulsation element, in particular the actuating element 603 (such as the roller of FIG. 9 or the actuating elements of FIGS. 6 to 8), a gearbox 602 can be arranged, which effects a specific transmission ratio of the speed of the drive motor and the frequency of the actuating element. This transmission ratio can be adjusted depending on the application. In principle, it is also conceivable that different transmission ratios can be implemented with one and the same gearbox, as is well known from gearboxes in drive technology. This allows the frequency of the pulsation to be adjusted, which can be particularly advantageous with regard to different areas of application for this pulsation effect (massage function on the one hand, support for an entertainment system on the other, for example). For example, it can be provided that the control unit is connected to the gearbox and can effect a controlling of the transmission ratio, for example depending on a desired or required pulsation frequency for certain applications. While the air cushion arrangement according to the invention has been described here only in general terms, it may be provided in particular that this air cushion arrangement is arranged in the region of a backrest of a vehicle seat and/or in the region of a seat surface of a vehicle seat. In particular, a combination of this air cushion arrangement with a lumbar support system, as is now frequently used in the automotive industry, can be implemented in a seat. The number of air cushions in the air supply system, which exert pressure on the body of the seated person, is in principle arbitrary and can comprise around 10 or 20 air cushions. All numbers of air cushions are conceivable here. In particular, it is intended that the pulsation device, e.g. as a pulsation module, and the air cushions of the air cushion arrangement are installed in the seat. The air supply system, on the other hand, does not necessarily have to be located in the seat and can also be located in a vehicle floor, for example. Alternatively, for example, the air cushion arrangement can be arranged in the backrest of the seat, whereas the air supply system is arranged in the seat surface.

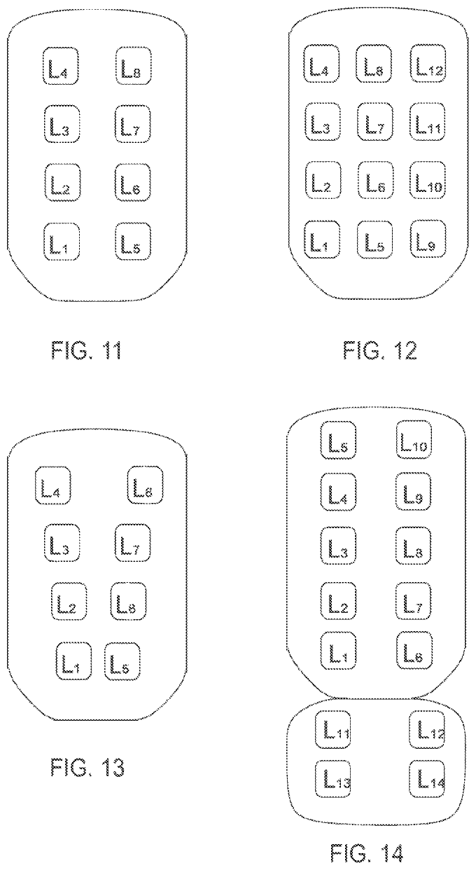

FIG. 11 schematically shows an air cushion device in a backrest with eight air cushions. In the air cushion device, the air cushions L₁ to L₄ are arranged in a first vertical row and the air cushions L₅ to L₈ are arranged in a second vertical row. Here, the air cushions L₁ and L₅ are at the same height horizontally. Thus, in one embodiment, a first group of air cushions L₁ to L₄ and a second group of air cushions L₅ to L₈ can be formed for control or, alternatively, 4 groups of two horizontally adjacent air cushions can be formed. For example, L₁ and L₅ are horizontally adjacent here.

The following is an example of some control sequences for the air cushions L₁ to L₈, wherein L₁-L₅ means that the air cushions are controlled as a group simultaneously and uniformly/in phase, and L₁< >L₅ means that the air cushions are controlled simultaneously but with antiphase pulsation, and L₁, L₂ means that at time t₁ the air cushion L₁ is controlled, in particular subjected to the pulsation, and at the time t₁=t+Δt, the air cushion L₂.

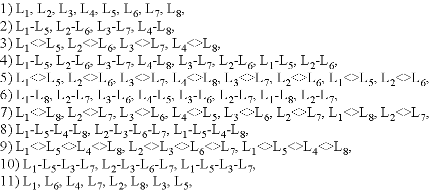

Here, options 1-5 are more suitable for encouraging the user to move, while options 6 and 9 are more suitable for preventing the user from moving. Further combinations can be presented by the person skilled in the art. It is also possible to change the sequence in which the air cushions are controlled, e.g. randomly controlled.

FIG. 12 schematically shows an air cushion device in a backrest with twelve air cushions. In the air cushion device, the air cushions L₁ to L₄ are arranged in a first vertical row, the air cushions L₅ to L₈ are arranged in a second vertical row and the air cushions L₉ to L₁₂ are arranged in a third vertical row. The air cushions L₁ and L₅ and L₉ are at the same height horizontally. Thus, in one embodiment, a first group of air cushions L₁ to L₄, a second group of air cushions L₅ to L₈ and a third group of air cushions L₉ to L₁₂ can be formed for control, or alternatively four groups of three horizontally adjacent air cushions can be formed. As a further alternative, the outer air cushions can form one group and the middle row can form another group. In such an embodiment, with regard to the pulsation, a phase shift of 120 degrees, for example, can also be convenient in addition to an in-phase or, respectively, antiphase control.

FIG. 13 provides a schematic representation of a further embodiment of an air cushion device in a backrest with eight air cushions. In the air cushion device, the air cushions L₁ to L₄ are arranged in a first row and the air cushions L₅ to L₆ are arranged in a second row. The distance between the air cushions is small for the air cushions L₁ and L₅ and increases with increasing distance from a seat cushion for the pairs L₂ and L₆, L₃ and L₇ and L₄ and L₈, so that the air cushions L₁ to L₈ are essentially arranged in a V-shape. Here, the air cushions L₁ and L₅ are at the same height horizontally. Thus, in one embodiment, a first group of air cushions L₁ to L₄ and a second group of air cushions L₅ to L₈ can be formed for actuation or, alternatively, 4 groups of two horizontally adjacent air cushions can be formed.

FIG. 14 shows a further embodiment of an air cushion device. In this device, the air cushions in the backrest are arranged as in FIG. 11, but in this case extended by a further pair of air cushions. Optionally, air cushions are also arranged in two rows in the seat cushion.

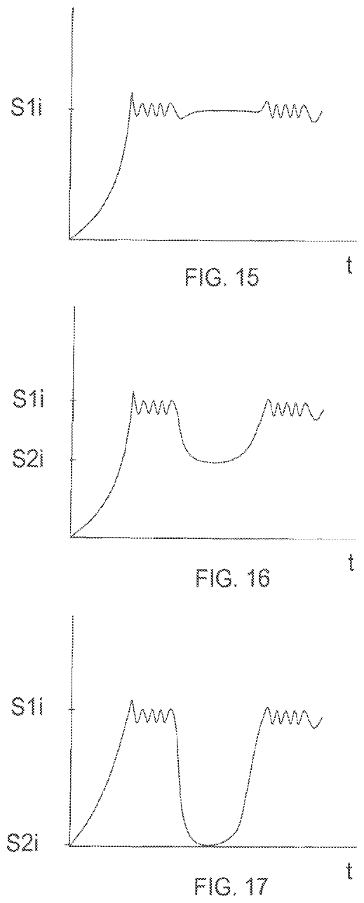

FIG. 15 shows the time sequence of the massage for an air cushion Lᵢ in one embodiment. Step 1 is performed first and the air cushion Lᵢ is filled with air up to a first threshold value S1ᵢ for the air cushion Lᵢ. When the threshold value S1ᵢ is reached, step 2 is performed and a pulsation Paᵢ is applied to the air cushion Lᵢ. Step 2 is performed here for a first time interval and then the pulsation is interrupted and after a further time interval a pulsation Paᵢ is again applied to the air cushion Lᵢ. In the example shown, the filling quantity of air remains essentially the same after the threshold value is reached, so that apart from the pulsation, the air cushion is not emptied and refilled.

FIG. 16 shows a modification of the method in FIG. 15. After a pulsation Paᵢ has been applied to the air cushion Lᵢ, step 3 is performed and the air cushion Lᵢ is emptied to a second threshold value S2ᵢ for the air cushion Lᵢ. Steps 1 and 2 are then performed again, i.e. the air cushion Lᵢ is filled with air up to a first threshold value S1ᵢ for the air cushion Lᵢ and, when the threshold value S1ᵢ is reached, the air cushion Lᵢ is subjected to a pulsation Paᵢ.

FIG. 17 shows a modification of the method in FIG. 16. After a pulsation Paᵢ has been applied to the air cushion Lᵢ, step 3 is performed and the air cushion Lᵢ is emptied up to a second threshold value S2ᵢ for the air cushion Lᵢ, wherein the emptying step is a complete or almost complete emptying of the air cushion Lᵢ here.

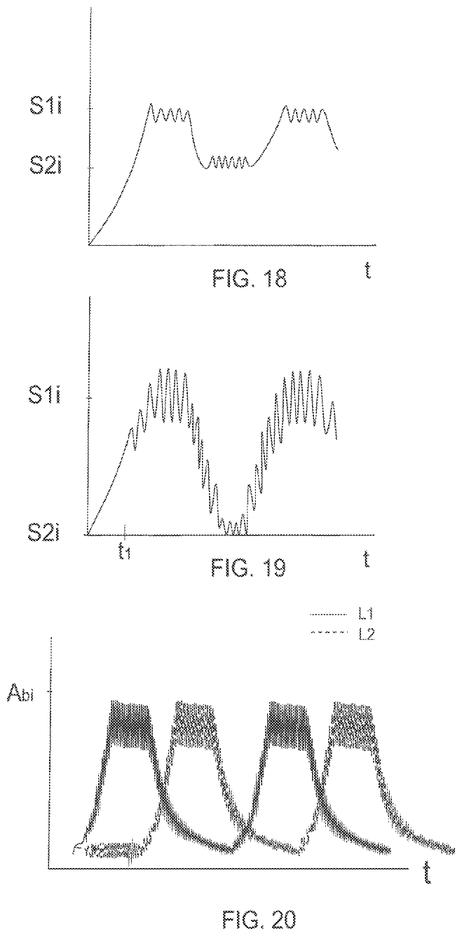

FIG. 18 shows a modification of the method in FIG. 16. After a pulsation Paᵢ has been applied to the air cushion Lᵢ, step 3 is carried out and the air cushion Lᵢ is emptied to a second threshold value S2ᵢ for the air cushion Lᵢ. Step 2 is then performed again and a pulsation Paᵢ is applied to the air cushion Lᵢ. Step 2, i.e. the pulsation, is stopped again after a time interval and air is applied again to the air cushion in a step 1 up to the first threshold value S1ᵢ.

In an alternative embodiment shown in FIG. 19, step 2 is started with a time offset to step 1 at the time t₁ and then performed uninterruptedly over multiple cycles of filling and emptying the air cushion Lᵢ, i.e. of a standard massage oscillation. Steps 1 and 2 can also be started simultaneously at the beginning of the cycle.

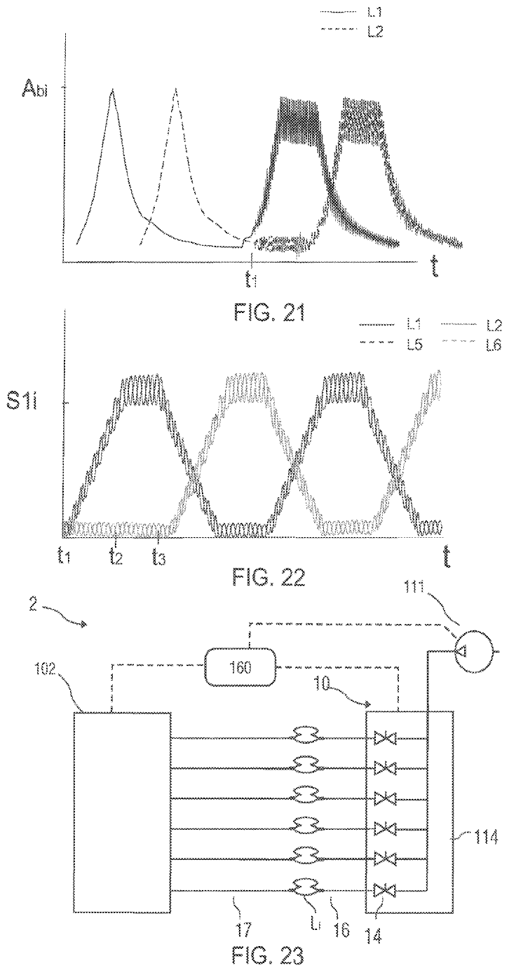

FIGS. 20 and 21 show a further embodiment of the massage method with two air cushions, wherein the first air cushion is shown with a solid line and the second air cushion with a dashed line. In FIG. 21, a standard massage oscillation with an amplitude Abᵢ and a frequency fbᵢ is first applied to the air cushions. This means that steps 1 and 3 are carried out sequentially first. Starting with time t₁, a pulsation with amplitude Aaᵢ and frequency faᵢ is applied to both air cushions, so that the standard massage oscillation is superimposed with the pulsation. In FIG. 10, starting with the very first cycle, the pulsation is superimposed with the massage oscillation with amplitude Abᵢ and a frequency fbᵢ. A first pressure maintaining interval is shown here between step 1 and step 3, during which the air cushion is neither actively filled nor emptied, but is subjected to pulsation at an essentially constant or only slightly decreasing pressure. In the case shown, the standard massage oscillation for the first and second air cushion is time-shifted in relation to each other, while the pulsation is added at the same time with the same frequency and amplitude for all air cushions. The pulsation is implemented here in particular with a module that applies a pulsation to all air cushions simultaneously. Depending on the embodiment of the module, a pulsation that has the same phase or an opposite phase (antiphase) or a pulsation with a predetermined phase offset between the air cushions can be applied to the air cushions.

FIG. 22 schematically shows a further embodiment of the massage method, in this case for four air cushions. The air cushion L₁ and L₅ are the first pair to be filled with air in parallel, i.e. step 1 is performed between t₁ and t₂. Starting at time t₁, the pulsation according to step 2 is also applied to air cushions L₁ and L₅. However, here the pulsation for the air cushions L₁ and L₅ is antiphasic with the same strength and frequency. From time t₂ to t₃, a pressure maintaining interval is shown in which the pulsation runs continuously. Starting at time t₃, step 3 is performed and the air cushion is emptied until time t₅. In a nearly emptied state, the pressure in the air cushion is again maintained for a second pressure maintaining interval while the pulsation runs continuously. The air cushions L₁ and L₅ can, for example, correspond to the air cushions L₁ and L₅ shown in FIG. 1. The pressure fluctuation in the cushions resulting from the superposition is higher during the first pressure maintenance phases, i.e. when filling up to the first threshold value S1ᵢ, than during filling or emptying of the respective cushion Lᵢ, as indicated in the representation.

Furthermore, the air cushions L₂ and L₆ are shown in gray as the second pair or, respectively, second group. The course of the curves for the air cushions L₂ and L₆ essentially corresponds to that of the air cushions L₁ and L₅, but begins with a second pressure maintaining interval, which lasts at least until the start of the emptying of the air cushions L₁ and L₅ and possibly also until the end of the emptying of the air cushions L₁ and L₅. At a time t₄, step 1 then begins for the air cushions L₂ and L₆, i.e. well after step 2. The cushions L₂ and L₆ can be the corresponding air cushions shown in FIG. 1. If further pairs of air cushions are integrated into the method, e.g. two further pairs as shown in FIG. 1, the second pressure maintaining intervals in particular become longer, so that step 1 for the first pair of air cushions only starts again upon emptying of the fourth pair of air cushions.

Even if the methods shown in FIGS. 15 to 22 are only shown for one, two or, respectively, four air cushions respectively, the methods described can be applied to the air cushion arrangements shown in FIGS. 11 to 14, for example by applying the methods simultaneously or with a time offset to individual or corresponding groups of air cushions.

FIG. 23 shows an example of a schematic diagram of another air cushion device 2 similar to that in FIG. 5. The air cushion device 2 comprises a plurality of air cushions Lᵢ, which are connected to an air supply system 10 via supply lines 16. The air supply system 10 comprises a common pressure supply 111, which is connected to the individual supply lines 16 via a valve unit 114 with a plurality of valves 14. In this embodiment, a valve 14 is assigned to each air cushion Lᵢ. A valve can be a 3/2-way valve or a 3/3-way valve, for example. In principle, it is also possible, for example, to assign a valve 14 to air cushions Lᵢ in pairs or groups so that two or more air cushions Lᵢ are filled at the same time. When a target pressure is reached in the respective air cushion Lᵢ, the respective valve 14 can be closed so that the air cushion Lᵢ is pneumatically disconnected from the air supply 10. The valves can be controlled, for example, via the control unit 160, such as the on-board computer of a vehicle.

In one embodiment, the control unit 160 can control a separate valve control unit or comprise such a unit. In the embodiment shown, the control unit 160 also controls the pulsation module 102, as described further below.

The air cushion device 2 further comprises a pulsation module 102. The pulsation module is designed to apply a pulsation to the Lᵢ air cushions individually, in groups or all together. For this purpose, the pulsation module is connected to the air cushions Lᵢ, in particular via the lines 17. As shown, a line 17 can be connected separately to the air cushion Lᵢ or lead into the supply line 16. The pulsation module can, for example, comprise one or multiple air chambers which apply a pulsation Paᵢ to the air cushions Lᵢ via one or more actuating elements. In particular, the air cushions Lᵢ can be arranged in a seat or, respectively, the seat backrest as shown in FIGS. 11-14.

The air cushion device shown in FIG. 5 or 23 is particularly suitable for carrying out the method according to the invention.

### REFERENCE SYMBOL LIST

2 Air cushion device
4 Seat
6 Air cushion
8 Air inlet
9 Further air inlet
10 Air supply system
12 Valve control unit
14 Valve
16 Supply line
17 Line
20, 220, 230, 240, 300, 400, 500 Pulsation device
21 Vibration device
22 Air chamber
23, 223, 313, 321 Membrane
24 Drive element
25, 224, 232, 242, 312, 502, 603 Actuating element
26 Further valve
102 Pulsation module
111 Pressure supply
113 Line
114 Valve unit
121 Pneumatic element
160 Control unit
221, 231, 241 Drive
222, 244 Interior volume
225, 234, 245 Limit surface
233, 322, 401, 402, 505,506, 507, 508 Pneumatic cushion
243 Sealing arrangement
301 Air volume
314 Line
315 Region
316 Housing
411 Pivot arm
412 Axis
441, 442 Counter-pressure element
501 Limit cylinder
503 Central axis
504 Roller
600 Drive arrangement
601 Drive motor
602 Gearbox
Lᵢ Air cushion

1. An air cushion device for a seat, comprising at least one air cushion, wherein the at least one air cushion has an air inlet in order to be individually filled with air via an air supply system, further comprising a pulsation device, which is fluidically connected to the air cushion, in order to apply a pressure oscillation to the air cushion.

2. The air cushion device according to claim 1, wherein the at least one air cushion has a further air inlet, wherein the pulsation device is connected to the further air inlet.

3. The air cushion device according to claim 1, wherein the air supply system comprises a valve control unit and a valve for each air cushion of the at least one air cushion, wherein the valve control unit is used to control the valve or valves, wherein the valves are arranged in a valve unit.

4. The air cushion device according to claim 1, wherein the air cushion device comprises a vibration device, which is arranged separately from the pulsation device and is controllable.

5. (canceled)

6. The air cushion device according to claim 1, wherein the pulsation device comprises a pneumatic element with an air chamber with a variable volume and a drive element and/or actuating element for changing a volume in the air chamber, wherein the air chamber is fluidically connected to the air cushion, wherein the actuating element is assigned to exactly one air chamber.

7. The air cushion device according to claim 6, wherein the air chamber is configured as a pneumatic cushion, or wherein the actuating element is configured for out-of-phase actuation of multiple pneumatic elements, and/or wherein the actuating element comprises a pivot arm which is pivotable through an angle about an axis, wherein respectively at least one pneumatic element is arranged on opposite sides of the pivot arm; or wherein the actuating element is arranged so as to be moveable linearly along an actuating path, wherein respectively at least one pneumatic element is arranged on opposite sides of the actuating element.

8. (canceled)

9. (canceled)

10. The air cushion device according to claim 6, wherein the pulsation device comprises a cylinder, in an interior of which pneumatic elements with an interior volume connected to the line in a pressure-balanced manner are arranged concentrically, wherein the actuating element comprises a roller arranged eccentrically to the cylinder within the cylinder, wherein the pneumatic elements and the actuating element are arranged in such a way that an eccentric movement of the roller about the longitudinal axis of the cylinder can change the interior volume of the pneumatic elements for applying a pulsation to the air cushion.

11. (canceled)

12. The air cushion device according to claim 6, wherein the pulsation device comprises one of a magnetic oscillating drive, a mechanical crank drive, or an electroactive polymer as drive element.

13. (canceled)

14. The seat comprising a seat surface and a backrest having the air cushion device according to claim 1.

15. A massage method for the air cushion device according to claim 1,
wherein the air cushion device comprises a number N, with N>1, of air cushions Lᵢ, wherein 1≤i≤N, comprising:
Step 1; Filling an air cushion Lᵢ to a first threshold value S1ᵢ for the air cushion Lᵢ,
Step 2: Applying a pulsation Paᵢ to the air cushion Lᵢ,
wherein the first threshold value S1ᵢ is selected for at least one of the N air cushions Lᵢ such that the air cushion is at least partially filled with air.

16. The massage method according to claim 15,
wherein the first threshold value S1ᵢ is a first filling pressure P1ᵢ or a first filling volume V1ᵢ in the air cushion Lᵢ.

17. The massage method according to claim 15, wherein step 2 is performed after ending step 1.

18. The massage method according to claim 15, further comprising:
Step 3; Emptying an air cushion Lᵢ to a second threshold value S2ᵢ for the air cushion Lᵢ, wherein step 3 is carried out after step 1 or after steps 1 and 2.

19. The massage method according to claim 18, further comprising:
Cyclically carrying out steps 1 and 3 so that a standard massage oscillation Pbᵢ is applied to the air cushion Lᵢ, so that the standard massage oscillation Pbᵢ and the pulsation Paᵢ are applied to the air cushion Lᵢ simultaneously or intermittently, and optionally; a first pressure maintaining interval is provided after step 1 and step 3 and/or wherein a second pressure maintaining interval is provided after step 3 and before step, wherein optionally step 2 is performed during the first pressure maintaining interval and/or during the second pressure maintaining interval.

20. (canceled)

21. The massage method according to claim 15, wherein the pulsation Paᵢ has a frequency of 1 Hz to 1000 Hz or 3 Hz to 100 Hz or 60 Hz to 80 Hz or between 5 and 20 Hz, or
wherein the pulsation Paᵢ takes place with a pressure difference of 5-100 hpa, and/or
wherein the pulsation Paᵢ takes place with a pressure difference of 5-15 ml, and/or
wherein the pulsation Paᵢ takes place with a pressure difference of 50%, of the maximum filling volume.

22. (canceled)

23. The massage method according to claim 16, wherein the second threshold value and the first threshold value are pressure threshold values, wherein a difference between the first threshold value and the second threshold value is 500 hPa, or wherein the second threshold value and the first threshold value are volume threshold values, wherein a difference between the first threshold value and the second threshold value is 0-150 ml,
or
wherein the second threshold value and the first threshold value are volume threshold values,
wherein a difference between the first threshold value and the second threshold value is 1000%-40% of the maximum filling volume.

24. The massage method according to claim 15, wherein for filling the air cushion Lᵢ runs by means of an air supply system, a pump of the air supply system runs exclusively during step 1.

25. The massage method according to claim 15, wherein the pulsation is generated by a pulsation module which is connectable or connected to each air cushion Lᵢ or to a first group of air cushions and generates a pulsation continuously or at a predetermined time interval.

26. The massage method according to claim 15, wherein the steps 1, step 2 and optionally step 3 for the N air cushions take place in a predetermined sequence, so that step 1 for the air cushion Lᵢ begins at the time t1ᵢ and step 2 for the air cushion Lᵢ begins at the time t2ᵢ and optionally step 3 for the air cushion Lᵢ begins at the time t3ᵢ, and optionally wherein at least one group of the air cushions is arranged such that the air cushions Lᵢ₋₁ and Lᵢ₊₁ are arranged on opposite sides of the air cushion Lᵢ, wherein each step starts at a time t−Δt for the air cushion Lᵢ₋₁ and a time t+Δt for the air cushion Lᵢ₊₁.

27. (canceled)

28. The massage method according to claim 15, wherein the N air cushions are divided into at least two groups, which are arranged in a respective row or a cluster, wherein the air cushions of a group are respectively controlled in parallel or wherein respectively one air cushion in a group is controlled in parallel with a corresponding air cushion of the other groups.

29. (canceled)
